(19) United States
(12) Patent Application Publication
(10) Pub. No.: US 2026/0074439 A1
(43) Pub. Date: Mar. 12, 2026

(54) RADIATING ELEMENTS HAVING COMMON MODE RESONANCE REJECTION CIRCUITS AND RELATED BASE STATION ANTENNAS

(71) Applicant: Outdoor Wireless Networks LLC, Richardson, TX (US)

(72) Inventors: Cheng Xue, Suzhou (CN); Changfu Chen, Suzhou (CN); Jian Zhang, Suzhou (CN); Bin Sun, Suzhou (CN); Pengfei Guo, Suzhou (CN); YueMin Li, Suzhou (CN)

(21) Appl. No.: 19/312,407

(22) Filed: Aug. 28, 2025

(30) Foreign Application Priority Data
Sep. 11, 2024 (CN) 202411269436.0

(51) Int. Cl. H01Q 21/26; H01Q 1/24; H01Q 21/06

(52) U.S. Cl. CPC H01Q 21/26; H01Q 1/246; H01Q 21/062

(57) ABSTRACT

A radiating element for a base station antenna comprises a feed stalk printed circuit board and a dipole radiator printed circuit board mounted on the feed stalk printed circuit board. The feed stalk printed circuit board includes a first ground line that includes a first integrated parallel LC circuit, a second ground line that includes a second integrated parallel LC circuit, a first signal trace that extends through an opening in the dipole radiator printed circuit board, and a second signal trace.

### CROSS-REFERENCE TO RELATED APPLICATION

The present application claims priority to Chinese Patent Application Serial No. 2024112694360, filed Sep. 11, 2024, the entire content of which is incorporated herein by reference.

### FIELD

The present disclosure relates to communications systems and, in particular, to base station antennas for cellular communications systems.

### BACKGROUND

Cellular communications systems are well known in the art. In a cellular communications system, a geographic area is divided into a series of regions that are referred to as “cells” which are served by respective base stations. Each base station may include one or more base station antennas that are configured to provide two-way radio frequency (“RF”) communications with mobile subscribers that are within the cell served by the base station. Typically, the base station antennas are mounted on a tower or other raised structure, with the radiation patterns (also referred to herein as “antenna beams”) that are generated by the base station antennas directed outwardly.

A common base station configuration is the three sector configuration in which a cell is divided into three 120° “sectors” in the azimuth (horizontal) plane. A separate base station antenna provides coverage (service) to each sector. Typically, each base station antenna will include multiple vertically-extending columns of radiating elements that operate, for example, using second generation (“2G”), third generation (“3G”) or fourth generation (“4G”) cellular network protocols. These vertically-extending columns of radiating elements are typically referred to as “linear arrays,” and may be straight columns of radiating elements or columns in which some of the radiating elements are staggered horizontally to narrow the beamwidths of the generated antenna beams in the azimuth (horizontal) plane. Most modern base station antennas include both “low-band” linear arrays of radiating elements that support service in some or all of the 617-960 MHz frequency band and “mid-band” linear arrays of radiating elements that support service in some or all of the 1427-2690 MHz frequency band.

These linear arrays are typically formed using dual-polarized radiating elements, which allows each linear array to be connected to a pair of radios (or radio ports of a single radio) so that the linear array can transmit and receive RF signals at two orthogonal polarizations (i.e., an antenna beam is generated at each orthogonal polarization).

Each of the above-described linear arrays of dual-polarized radiating elements is coupled to two ports of a radio (one port for each polarization). An RF signal that is to be transmitted by one of the linear arrays is passed from the radio to the antenna where it is divided into a plurality of sub-components, with each sub-component fed to a respective subset of the radiating elements in the linear array. The sub-components of the RF signal are transmitted through the radiating elements to generate an antenna beam that covers a generally fixed coverage area, such as a 120° sector of a cell. Typically these linear arrays will have remote electronic tilt (“RET”) capabilities which allow a cellular operator to change, from a control center, the pointing angle of the generated antenna beams in the elevation (vertical) plane in order to change the size of the sector served by the linear array (since the more that the antenna beam is downtilted in the elevation plane, the smaller the area that is illuminated by the antenna beam, and hence the smaller the size of the area covered by the antenna beam). Since the antenna beams generated by the above-described 2G/3G/4G linear arrays are static antenna beams that only change in shape due to adjustments in the downtilt angle of the antenna beam, they are often referred to as “passive”linear arrays.

Cellular operators are currently upgrading their networks to support fifth generation (“5G”) cellular service. One important component of 5G cellular service is the use of multi-column “active” beamforming arrays that operate in conjunction with beamforming radios. The beamforming radios change the amplitudes and/or phases of the sub-components of a signal that is to be transmitted. The sub-components of the signal are passed to respective subsets of the radiating elements of the active beamforming array in order to dynamically adjust the size, shape and pointing direction of the generated antenna beams. These active beamforming arrays are typically formed using “high-band” radiating elements that operate in higher frequency bands, such as some or all of the 3.3-4.2 GHz frequency bands, although active beamforming radios may also be provided that operate in other frequency bands such as the upper portion (e.g., 2.5-2.7 GHz) of the mid-band frequency range. The radiating elements in each vertically-extending column of such an active beamforming array are typically coupled to a respective port of a beamforming radio so that each column of radiating elements is fed a different sub-component of the signal to be transmitted. The beamforming radio may be a separate device, or may be integrated with the active antenna array. As discussed above, the beamforming radio may adjust the amplitudes and phases of the sub-components of an RF signal that are fed to each port of the radio (and hence to each respective column of radiating elements in the multi-column beamforming array) in order to generate antenna beams that have narrowed beamwidths in the azimuth plane (and hence higher antenna gain). These narrowed antenna beams can be electronically steered throughout the sector by proper selection of the amplitudes and phases of the sub-components of the RF signal. In order to avoid having to increase the number of antennas at cell sites, 5G antennas that include such beamforming arrays also often include passive linear arrays that support legacy 2G, 3G and/or 4G cellular services.

### SUMMARY

Pursuant to some embodiments of the present invention, radiating elements for a base station antenna are provided that comprise a feed stalk printed circuit board and a dipole radiator printed circuit board mounted on the feed stalk printed circuit board. The feed stalk printed circuit board includes a first ground line that includes a first integrated LC circuit, a second ground line that includes a second integrated parallel LC circuit, a first signal trace that extends through an opening in the dipole radiator printed circuit board, and a second signal trace.

In some embodiments, the second signal trace extends through the opening.

In some embodiments, the feed stalk printed circuit board includes a forwardly-extending tab that extends through the opening, and a distal end of the first signal trace extends onto the first forwardly-extending tab.

In some embodiments, the dipole radiator printed circuit board includes a first dipole arm piece and a second dipole arm piece that are each at least part of a first dipole radiator, and a third dipole arm piece and a fourth dipole arm piece that are each at least part of a second dipole radiator. In some embodiments, the first signal trace is galvanically connected to the first dipole arm piece and the second signal trace is galvanically connected to the second dipole arm piece. In some embodiments, the radiating element may further comprise a first dipole arm extension that is electrically connected to the first dipole arm piece, a second dipole arm extension that is electrically connected to the second dipole arm piece, a third dipole arm extension that is electrically connected to the third dipole arm piece, and a fourth dipole arm extension that is electrically connected to the fourth dipole arm piece. The first dipole arm extension may overlap the first dipole arm piece in a forward direction and extends outwardly beyond an outer perimeter of the first dipole arm piece. The first dipole arm extension may comprise a sheet metal dipole arm extension that includes a first portion that extends in parallel to the first dipole arm piece and a second portion that extends at an oblique angle from the first portion. In some embodiments, the first dipole arm extension may be capacitively coupled to the first dipole arm piece. In some embodiments, the first through fourth dipole arm extensions are separate pieces. In other embodiments, at least two of the first through fourth dipole arm extensions are implemented in a single piece of sheet metal.

In some embodiments, the first and second signal traces each have a plurality of meandered segments.

In some embodiments, a first portion of the first signal trace has a wave shape with at least two peaks and two valleys.

In some embodiments, no parallel LC circuit is integrated into either the first signal trace or the second signal trace.

In some embodiments, the radiating element may further comprise a base board printed circuit board that includes a slot therethrough, where a base of the feed stalk printed circuit board is inserted through the slot in the base board printed circuit board. A rear side of the base board printed circuit board may include a metal pad, and a plurality of ground traces on the feed stalk printed circuit board may be soldered to the metal pad.

In some embodiments, the radiating element is provided in combination with a cavity phase shifter assembly that comprises a metal shell having first and second cavities, a first phase shifter within the first cavity, and a second phase shifter within the second cavity. The metal pad on the base board printed circuit board may be mounted to capacitively couple with the metal shell. A front wall of the metal shell may include first and second openings, and the first phase shifter comprises a first phase shifter printed circuit board and the second phase shifter comprises a second phase shifter printed circuit board, and the feed stalk printed circuit board includes a first rearwardly-extending tab that extends through the first opening to contact the first phase shifter printed circuit board and a second rearwardly-extending tab that extends through the second opening to contact the second phase shifter printed circuit board.

Pursuant to further embodiments of the present invention, radiating elements for a base station antenna are provided that comprise a feed stalk printed circuit board and a dipole radiator printed circuit board mounted on a distal end of the feed stalk printed circuit board. The feed stalk printed circuit board includes a first ground line that includes a first integrated parallel LC circuit, a second ground line that includes a second integrated parallel LC circuit, a first signal trace that has a plurality of meandered segments that directly connects to the dipole radiator printed circuit board and that does not include an integrated LC circuit, and a second signal trace that has a plurality of meandered segments that directly connects to the dipole radiator printed circuit board and that does not include an integrated LC circuit.

In some embodiments, the feed stalk printed circuit board includes a forwardly-extending tab that extends through an opening in the dipole radiator printed circuit board, and the first signal trace extends through the opening. In some embodiments, the second signal trace extends through the opening.

In some embodiments, no parallel LC circuit is integrated into either the first signal trace or the second signal trace.

In some embodiments, the dipole radiator printed circuit board includes a first dipole arm piece and a second dipole arm piece that are each at least part of a first dipole radiator, and a third dipole arm piece and a fourth dipole arm piece that are each at least part of a second dipole radiator. In some embodiments, the first signal trace is galvanically connected to the first dipole arm piece and the second signal trace is galvanically connected to the second dipole arm piece.

In some embodiments, the radiating element further comprises a first dipole arm extension that is electrically connected to the first dipole arm piece, a second dipole arm extension that is electrically connected to the second dipole arm piece, a third dipole arm extension that is electrically connected to the third dipole arm piece, and a fourth dipole arm extension that is electrically connected to the fourth dipole arm piece. In some embodiments, first dipole arm extension comprises a sheet metal dipole arm extension that includes a first portion that extends in parallel to the first dipole arm piece and a second portion that extends at an oblique angle from the first portion.

In some embodiments, the radiating element further comprises a base board printed circuit board that includes a slot therethrough, wherein a base of the feed stalk printed circuit board is inserted through the slot in the base board printed circuit board. In some embodiments, the radiating element is provided in combination with a cavity phase shifter assembly that comprises a metal shell having first and second cavities, a first phase shifter within the first cavity, and a second phase shifter within the second cavity, where the feed stalk printed circuit board includes a first rearwardly extending tab that extends into the first cavity, and a second rearwardly extending tab that extends into the second cavity.

Pursuant to additional embodiments of the present invention, radiating elements for a base station antenna are provided that comprise a feed stalk printed circuit board and a dipole radiator printed circuit board mounted on the feed stalk printed circuit board, wherein the feed stalk printed circuit board includes a first ground line that includes a first integrated parallel LC circuit, a second ground line that includes a second integrated parallel LC circuit, a first signal trace that is galvanically connected to a first metal pad on the dipole radiator printed circuit board, and a second signal trace that is galvanically connected to a second metal pad on the dipole radiator printed circuit board.

In some embodiments, no parallel LC circuit is integrated into either the first signal trace or the second signal trace.

In some embodiments, the dipole radiator printed circuit board includes a first dipole arm piece and a second dipole arm piece that are each at least part of a first dipole radiator, and a third dipole arm piece and a fourth dipole arm piece that are each at least part of a second dipole radiator. In some embodiments, the first signal trace is galvanically connected to the first dipole arm piece and the second signal trace is galvanically connected to the second dipole arm piece. In some embodiments, the first and second signal traces each have a plurality of meandered segments.

In some embodiments, the radiating element further comprises a base board printed circuit board that includes a slot therethrough, wherein a base of the feed stalk printed circuit board is inserted through the slot in the base board printed circuit board.

### BRIEF DESCRIPTION OF THE DRAWINGS

FIG. 1A is a front perspective view of a conventional base station antenna that includes both passive linear arrays and an active beamforming array.

FIG. 1B is a schematic front view of the conventional base station antenna of FIG. 1A with the radome removed.

FIG. 2A is a schematic front view of a base station antenna according to embodiments of the present invention with the radome removed.

FIG. 2B is a schematic front perspective view of four mid-band linear array assemblies of the base station antenna of FIG. 2A, with a main reflector of the base station antenna shown for context.

FIG. 3A is a schematic side perspective view of one of the mid-band radiating elements included in the mid-band linear array assemblies of FIG. 2B.

FIG. 3B is a schematic top view of the mid-band radiating element of FIG. 3A.

FIG. 3C is a schematic side view of the mid-band radiating element of FIG. 3A.

FIG. 3D is a schematic top view of the feed stalk printed circuit board of the mid-band radiating element of FIG. 3A.

FIG. 3E is a front view of the dipole radiator printed circuit board of the mid-band radiating element of FIG. 3A.

FIG. 4 is a schematic end view of one of the cavity phase shifter assemblies of FIG. 2B.

FIG. 5A is a schematic side perspective view of the mid-band radiating element of FIGS. 3A-3E mounted on the cavity phase shifter assembly of FIG. 4.

FIG. 5B is an enlarged side view of a portion of FIG. 5A.

It should be noted that herein reference numerals that include two numbers separated by a dash may be used, and that like elements may be referred to individually by their full reference numeral and may be referred to collectively by the first part of their reference numeral.

### DETAILED DESCRIPTION

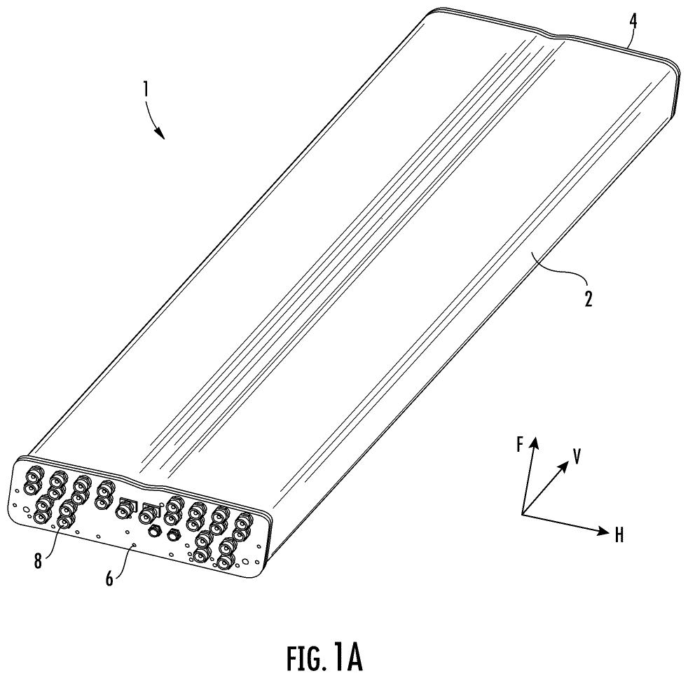

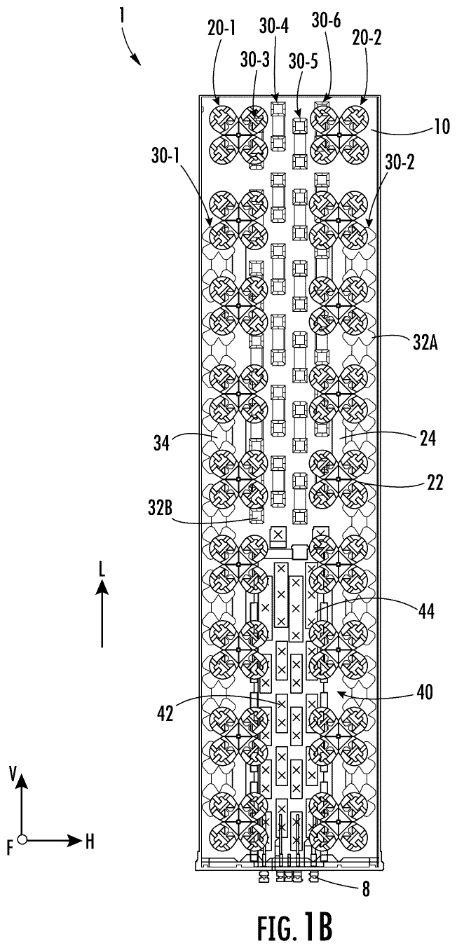

FIGS. 1A and 1B illustrate a conventional base station antenna 1 that includes both passive low-band and mid-band linear arrays and a high-band active beamforming array. In particular, FIG. 1A is a front perspective view of the base station antenna 1, and FIG. 1B is a schematic front view of the base station antenna 1 with the radome thereof removed. In FIGS. 1A and 1B, the axes illustrate the vertical (V), horizontal (H) and forward (F) directions of the base station antenna system 1. In the description that follows, each antenna will be described using terms that assume that the antenna is mounted for use on a tower with the longitudinal axis L of the antenna extending along the vertical axis V and the front surface of the antenna mounted opposite the tower pointing toward the coverage area for the antenna.

Referring to FIG. 1A, the base station antenna 1 has a tubular shape with a generally rectangular cross-section. The base station antenna 1 includes a radome 2 a top end cap 4 and a bottom end cap 6. A plurality of RF ports 8 in the form of RF connectors are mounted in the bottom end cap 6. The RF ports 8 extend through the bottom end cap 6 and are used to electrically connect the base station antenna 1 to external radios (not shown). The radome 2, top end cap 4 and bottom cap 6 may form an external housing for the antenna 1. An antenna assembly (FIG. 1B) is contained within the housing.

FIG. 1B is a schematic front view of the antenna assembly that is contained within the housing of base station antenna 1. As shown in FIG. 1B, the antenna assembly includes a reflector 10. The reflector 10 may serve as both a structural component for the antenna assembly and as a ground plane and reflector for at least some of the radiating elements (discussed below) of antenna 1. The reflector 10 includes a generally flat metallic surface that extends in the longitudinal direction L of the antenna 1. Various mechanical and electronic components of base station antenna 1 (not shown) are mounted behind the reflector 10.

The antenna assembly further includes first and second low-band arrays 20-1, 20-2 of low-band radiating elements 22, first and second mid-band arrays 30-1, 30-2 of first mid-band radiating elements 32A, third through sixth mid-band arrays 30-3 through 30-6 of second mid-band radiating elements 32B, and a multi-column high-band array 40 of high-band radiating elements 42. The low-band arrays 20 and mid-band arrays 30 are each implemented as vertically-extending linear arrays of radiating elements. The low-band and mid-band linear arrays 20, 30 may support, for example, 2G, 3G and/or 4G cellular service. Each of the low-band and mid-band linear arrays 20, 30 are passive arrays that generate static antenna beams that provide coverage to a predefined coverage area (e.g., antenna beams that are each configured to cover a 120° sector of a base station), with the only change to the coverage area occurring when the electronic downtilt angles of the generated antenna beams are adjusted (e.g., to change the size of the cell).

The high-band radiating elements 42 are mounted in four columns in the lower center portion of the reflector 10 to form the multi-column array 40. Each column of the multi-column array 40 may be coupled to a pair of ports (one for each polarization) of a beamforming radio so that the multi-column array 40 operates as an active beamforming array that generates narrowed antenna beams that can be steered in the azimuth plane throughout the coverage area.

The low-band radiating elements 22 are configured to transmit and receive signals in the 617-960 MHz frequency range or a portion thereof (e.g., the 617-896 MHz frequency band, the 696-960 MHz frequency band, etc.). The first mid-band radiating elements 32A are configured to transmit and receive signals in the 1427-2690 MHz frequency range or a portion thereof (e.g., the 1427-1710 MHz frequency band, the 1427-2200 MHz frequency band, etc.). The second mid-band radiating elements 32B are configured to transmit and receive signals in the 1695-2690 MHz frequency range or a portion thereof (e.g., the 1710-2200 MHz frequency band, the 2300-2690 MHz frequency band, etc.). The second mid-band radiating elements 32B may have a different design than the first mid-band radiating elements 32A. The high-band radiating elements 42 are configured to transmit and receive signals in the 3300-4200 MHz frequency range or a portion thereof. The radiating elements 22, 32A, 32B, 42 are mounted to extend forwardly from the reflector 10.

The low-band and mid-band radiating elements 22, 32A, 32B may each be implemented as dual-polarized radiating elements that each include first and second radiators that are configured to transmit and receive RF energy at orthogonal polarizations. For example, the low-band and mid-band radiating elements 22, 32A, 32B may be implemented as slant −45°/+45° cross-dipole radiating element that include a −45° dipole radiator and a +45° dipole radiator that are arranged to form a cross when the radiating elements 22, 32A, 32B are viewed from the front. The dipole radiators of each low-band and mid-band radiating element 22, 32A, 32B are mounted on a feed stalk (not visible in the figures) that passes RF signals between the dipole radiators and an associated feed network.

Since dual-polarized radiating elements are used, each of the low-band and mid-band linear arrays 20, 30 is connected to a pair of the RF ports 8. The first RF port 8 of each pair is connected to a first port of a passive (non-beamforming) radio (e.g., a remote radio head mounted on the antenna tower near the base station antenna 1), typically by a coaxial cable. A feed cable and a feed network connect the first RF port 8 to the first polarization radiators of the radiating elements 22, 32A, 32B in the respective linear arrays 20, 30. Similarly, the second RF port 8 of each pair is connected to a second port of the radio by a coaxial cable, and another feed cable and feed network connect the second RF port 8 to the second polarization radiators of the radiating elements 22, 32A, 32B in a respective one of the linear arrays 20, 30. RF signals that are to be transmitted by a selected one of the low-band and mid-band linear arrays 20, 30 are passed from the associated radio to one of the RF ports 8, and passed from the RF port 8 to the associated feed network. Each feed network may include a phase shifter assembly that includes a power divider that divides the RF signal into a plurality of sub-components that are fed to the respective first or second radiators of the radiating elements 22, 32A, 32B in the linear array 20, 30 so that the sub-components are radiated into free space. Accordingly, each linear array 20, 30 may be used to form a pair of antenna beams, namely an antenna beam for each of two different polarizations. Each linear array 20, 30 may be configured to provide service to a sector of a base station. For example, each linear array 20, 30 may be configured to provide coverage to approximately 120° in the azimuth plane so that the base station antenna 1 may act as a sector antenna for a three-sector base station.

The high-band radiating elements 42 are also implemented as dual polarized slant −45°/+45° cross-dipole radiating elements. Each column of high-band radiating elements 42 is coupled to a pair of ports (one port for each polarization) of a beamforming radio (not shown) that may be, for example, mounted on the antenna tower adjacent the antenna 1. The beamforming radio is capable of electronically adjusting the amplitudes and/or phases of the subcomponents of an RF signal that are output to each column of high-band radiating elements 42 of the multi-column beamforming array 40. The beamforming radio may change the size, shape and pointing direction of the generated antenna beams by adjusting the amplitudes and/or phases of the subcomponents of an RF signal that are output to each column. These adjustments may be made, for example, on a time slot by time slot basis of a time division multiple access scheme.

As shown best in FIG. 1B, the low-band radiating elements 22 may be mounted on low-band feed board printed circuit boards 24, the mid-band radiating elements 32A, 32B may be mounted on mid-band feed board printed circuit boards 34, and the high-band radiating elements 42 may be mounted on high-band feed board printed circuit boards 44. The feed board printed circuit boards 24, 34, 44 couple RF signals between groups of one to three radiating elements 22, 32A, 32B, 42 and phase shifter assemblies that are interposed between the RF ports 8 and the arrays 20, 30, 40. Cables (not shown) may be used to connect each feed board printed circuit board 24, 34, 44 to the phase shifter assemblies.

While the conventional base station antenna 1 of FIGS. 1A-1B can support a wide range of communications services, in practice it can be difficult to manufacture. Cellular operators tend to have strict limitations on the acceptable physical sizes for various types of base station antennas, since the base station antennas are often mounted on tall antenna towers where they can be subject to very high wind loads. As the size of a base station antenna increases, wind-loading considerations can greatly increase the structural requirements for the antenna mounting hardware and the antenna tower, which can significantly increase the cost of implementing a base station. Thus cellular operators often place strict limits on the lengths, widths and/or depths of each type of base station antenna.

Multiband base station antennas that support cellular service in all three of the low-band, mid-band and high-band frequency ranges typically include at least eight columns of radiating elements, and often as many as twelve, sixteen or more columns of radiating elements. Because of the size constraints for the antenna, radiating elements that operate in different frequency bands are often in very close proximity within the antenna, which may cause the radiating elements from adjacent arrays to interact with each other, typically in undesirable ways. For example, the mid-band and/or high-band radiating elements are often mounted behind the low-band radiating elements. RF energy emitted by the mid-band/high-band radiating elements may therefore generate RF currents on the radiators of lower-band radiating elements, and these RF currents then cause the RF energy to re-radiate from the lower-band radiators. This process tends to distort the shape of the antenna beams of the higher-band (e.g., mid-band or high-band) linear arrays. Thus, the radiating elements of some or all of the lower-band arrays are often designed to be “cloaked” radiating elements that are substantially transparent to RF radiation emitted by the higher-band radiating elements in the base station antenna. As another example, RF radiation transmitted and received by the low-band radiating elements in a base station antenna can generate common mode currents on nearby mid-band radiating elements, since the combined length of the feed stalk and a dipole arm of most mid-band band radiating elements is about a quarter wavelength of various frequencies in of the low-band operating frequency range and hence common mode low-band currents may form on the combination of the feed stalk and dipole arm of the mid-band radiating elements. Low-band RF radiation may then be emitted from the mid-band radiating element in response to these common mode currents, which acts to distort the radiation patterns of the low-band linear arrays. As yet another example, RF radiation emitted by the might-band radiating elements may scatter when it impinges on metal structures on the feed stalks of nearby low-band and/or mid-band radiating elements.

Another problem with conventional multiband base station antennas is the difficulty in identifying and correcting problems that are uncovered during factory testing of production antennas. The feed networks included in multiband base station antennas are typically mounted behind the linear arrays, and the cables, phase shifters and other elements of the various feed networks are often intertwined. Each base station antenna is typically tested after the antenna is assembled to identify problems such as unintended passive intermodulation (“PIM”) distortion sources (such as poorly formed solder joints or loose metal-to-metal connections that can generate unwanted RF noise), faulty connections, inoperable components (e.g., phase shifters, RET units, etc.) and the like. When such problems are identified, it often is difficult to identify the source of the problem, let alone fix the problem, within the assembled antenna since it is difficult to access many of the components of the antenna (and in particular components that are behind the main reflector) due to the crowded design. As a result, when problems are identified, the base station antenna system often must be partly or completely disassembled to identify and fix the problems. This can greatly increase production costs.

Still another problem with current multiband base station antennas is that the RF paths to radiating elements of at least some of the low-band, mid-band and high-band arrays may cross back and forth between the front and back sides of the main reflector. As a result, the RF performance of these arrays cannot be tested until the base station antenna is assembled. If problems are identified, the antenna then typically has to be disassembled to fix the problems.

Pursuant to embodiments of the present invention, multi-band base station antennas are provided that address the above-discussed problems with conventional multiband base station antennas. The multiband base station antennas according to embodiments of the present invention have low-cost, high performance radiating elements that have low interaction on arrays operating in other frequency bands. In the embodiments discussed below, these radiating elements are implemented as mid-band radiating elements as an example, but it will be appreciated that the techniques disclosed herein may be used to form radiating elements that operate in other frequency bands. The radiating elements according to embodiments of the present invention may have a feed stalk that comprises a single printed circuit board, which reduces cost and which may also reduce the impact that the mid-band radiating elements have on nearby radiating elements that operate in other frequency bands. The radiating elements according to embodiments of the present invention may further include a small dipole radiator printed circuit board that is mounted on a distal end of the feed stalk printed circuit board, and a plurality of dipole arm extensions that may be mounted on and capacitively coupled to the dipole radiator printed circuit board. The radiating element may further include a base board printed circuit board that mechanically supports the feed stalk printed circuit board and that may alternatively be used to electrically connect the feed stalk printed circuit board to a ground reference.

In some embodiments, the base station antennas may include “wireless” cavity phase shifter assemblies for at least some of the mid-band linear arrays. “Wireless” phase shifter assemblies refer to phase shifter assemblies that have outputs that connect directly to the radiating elements of the array (or to feed board printed circuit boards for the radiating elements), thereby eliminating the need for coaxial “phase cables” that extend from the outputs of a conventional phase shifter assembly to the radiating elements (or feed board printed circuit boards) of the array. Each cavity phase shifter assembly includes a phase shifter that is mounted within a grounded metal shell so that the RF transmission lines of the phase shifter operate as low-loss stripline transmission lines.

The cavity phase shifter assemblies may be mounted behind a reflector of the base station antenna. The mid-band radiating elements according to embodiments of the present invention may be partially pre-assembled, with the feed stalk printed circuit board mounted on the base board printed circuit board, and the small dipole radiator printed circuit board mounted on the feed stalk printed circuit board. This simplifies the manufacturing response, since the mid-band linear arrays with their associated feed networks may be mostly assembled before they are installed into the base station antenna. In addition, prior to being mounted in the base station antenna, the dipole arm extensions may be removably mounted on the respective dipole radiator printed circuit boards so that the mid-band linear arrays and their associated feed networks may be pre-tested so that any defects may be identified and corrected before the cavity phase shifters and partially assembled radiating elements are mounted in the base station antenna.

The main reflector of the base station antenna may include a plurality of openings at the positions where the mid-band radiating elements are to be mounted. These openings may be slightly larger than the footprints of the base board printed circuit board and/or the dipole radiator printed circuit board so that the dipole radiator printed circuit board, the feed stalk printed circuit board and (optionally) the base board printed circuit board of each radiating element may be inserted through a respective one of the openings in the reflector when the cavity phase shifter assembly is mounted in the base station antenna. The dipole arm extensions may then be mounted on the dipole radiator printed circuit boards (e.g., using a plastic support) to complete the manufacture of the mid-band linear array. This process simplifies the manufacture of the base station antenna, and allows the base station antenna to include a common main reflector that serves as the ground plane for multiple linear arrays, which may improve performance.

One way in which low-band and mid-band linear arrays can interact in an undesirable way is that RF radiation transmitted and received by the low-band radiating elements may generate common mode currents on nearby mid-band radiating elements, since the combined length of the feed stalk and a dipole arm of most mid-band band radiating elements is about a quarter wavelength of various frequencies in of the low-band operating frequency range. As such, non-trivial common mode currents may be induced on the mid-band radiating elements when excited by RF energy in the low-band operating frequency range. The inducement of these common mode currents on the mid-band radiating element is referred to as a common mode resonance. These common mode resonances may distort the radiation patterns of the low-band linear arrays.

Mid-band radiating elements are known in the art that include common mode resonance rejection circuits that tune the common mode resonance to be outside the low-band operating frequency range. This can be accomplished, for example, by integrating an inductor-capacitor (“LC”) circuit into the electrical connections between a feed network for the mid-band radiating element and each of the four dipole arms of the mid-band radiating element. Conventionally, these LC circuits are implemented at least in part on the feed stalk of the cross-dipole radiating element. Since a cross-dipole radiating element has four dipole arms, four LC circuits may be implemented in whole or part on the feed stalk. These LC circuits (which typically are parallel LC circuits) may be effective in tuning the common mode resonance out of the low-band operating frequency range. However, they also require an increase in the size of the feed stalk, which increases the cost and weight of the mid-band radiating element, and the larger feed stalk may cause increased scattering of the RF energy emitted by any nearby high-band radiating elements.

The cross-dipole mid-band radiating elements according to embodiments of the present invention may only include two LC circuits in the feed stalks thereof, which allows for the use of smaller feed stalk printed circuit boards that are lighter and less expensive than comparable conventional feed stalk printed circuit boards. In fact, the radiating elements may use a single feed stalk printed circuit boards that may have the additional benefit of causing reduced scattering with respect to nearby high-band radiating elements.

In some embodiments, the mid-band radiating elements disclosed herein may be used in base station antennas that include a main reflector that is mounted directly in front of one or more cavity phase shifter assemblies. The main reflector may act as a ground plane for the mid-band radiating elements and may redirect forwardly RF radiation that is emitted rearwardly by the mid-band radiating elements. The reflector may include a respective opening at the locations where the mid-band radiating elements are to be mounted. The base board printed circuit board and the dipole radiator printed circuit board of each mid-band radiating element may be sized so that they may fit through these openings. This allows the mid-band radiating elements to be partially pre-assembled (i.e., the base board printed circuit board, the feed stalk printed circuit board and the dipole radiator printed circuit board of each radiating element may be assembled together) and soldered in place on the cavity phase shifter assemblies before the cavity phase shifter assemblies are installed within the base station antenna, which simplifies the manufacturing process. In addition, the dipole arm extensions and the director of each mid-band radiating element may be removably mounted on the dipole radiator printed circuit boards so that the mid-band linear array assemblies may be tested before they are installed in the antenna. As a result, poor solder joints, improper connections and other manufacturing issues can be identified and corrected before the antenna is assembled. After testing, the dipole arm extensions and the directors may be removed so that the cavity phase shifter assemblies may be mounted in the base station antenna with the partially assembled mid-band radiating elements extending through the openings in the main reflector. The dipole arm extensions and the directors may then be reinstalled on the partially assembled mid-band radiating elements in front of the main reflector to complete the fabrication of the mid-band linear array assemblies.

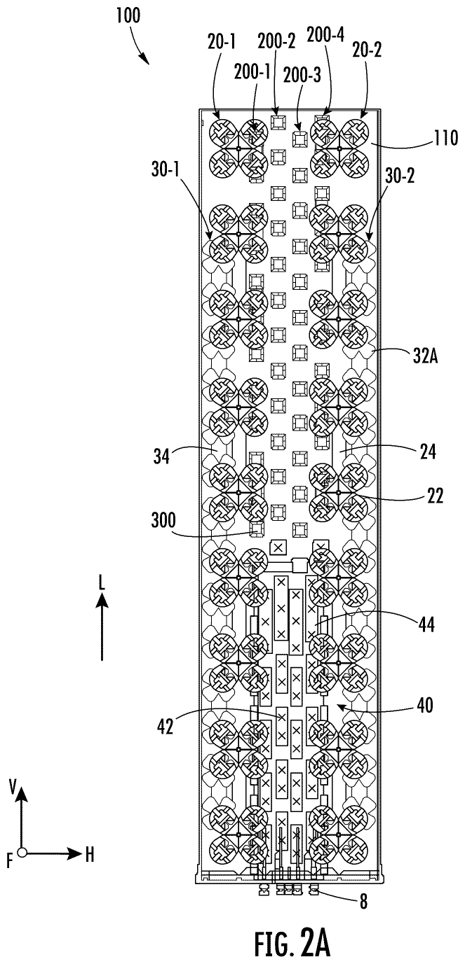

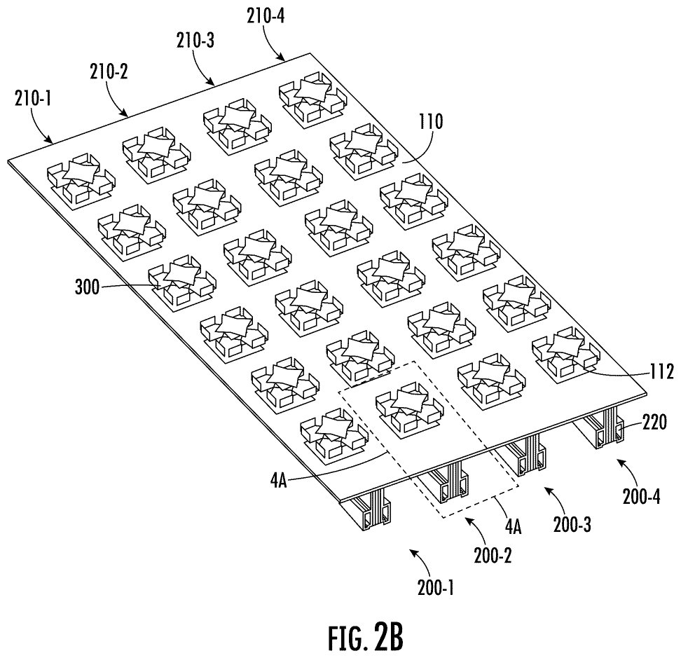

Embodiments of the present invention will now be described in greater detail with reference to FIGS. 2A-5.

FIG. 2A is a schematic front view of a multiband base station antenna 100 according to embodiments of the present invention with the radome removed. The multiband base station antenna 100 is similar to base station antenna 1 in many respects. Accordingly, the discussion below will focus on the differences between base station antenna 1 and base station antenna 100. Elements that are the same in the two base station antennas 1, 100 are labeled using the same reference numerals.

As can be seen by comparing FIGS. 1B and 2A, the primary difference between the two base station antennas 1, 100 is that the four mid-band linear arrays 30-3 through 30-6 of base station antenna 100 and their associated feed networks (which are not visible in FIGS. 1A-1B) are replaced in base station antenna 100 with four mid-band linear array assemblies 200-1 through 200-4. The reflector 10 of base station antenna 1 is also replaced in base station antenna 100 with a modified reflector 110. It should also be noted that the mid-band feed board printed circuit boards 34 of base station antenna 1, each of which includes two mid-band radiating elements 32 thereon, are omitted in base station antenna 100. As will be discussed in more below, the feed board printed circuit boards 32 of base station antenna 1 are replaced in base station antenna 100 with base board printed circuit boards 380 that are part of the mid-band radiating elements 300.

FIG. 2B is a schematic front perspective view of a portion of each of the four mid-band linear array assemblies 200-1 through 200-4 that are included in base station antenna 100. FIG. 2B also shows the reflector 110 of the base station antenna 100 for context. The mid-band radiating elements in adjacent mid-band linear array assemblies 200-1 through 200-4 are shown as being staggered (offset) vertically in FIG. 2A, but this stagger is not shown in FIG. 2B. It will be appreciated that either configuration is possible.

As shown in FIG. 2A, the reflector 110 may extend substantially the entire length of the base station antenna 100, which provides increased structural strength. As shown in FIG. 2B, each mid-band linear array assembly 200 includes a mid-band linear array 210 of mid-band radiating elements 300 and a cavity phase shifter assembly 220. The cavity phase shifter assemblies 220 form the feed networks for the respective mid-band linear arrays 210. The reflector 110 includes a plurality of openings 112. Each mid-band radiating element 300 extends through a respective one of the openings 112 in the reflector 110 so that most of each mid-band radiating element 300 is positioned forwardly of the reflector 110, but a small portion of each mid-band radiating element 300 extends rearwardly of the reflector 110. The cavity phase shifter assemblies 220 are mounted rearwardly of the reflector 110. Each mid-band radiating element 300 may be configured to operate in the 1695-2690 MHz frequency band, or a portion thereof.

To simplify the drawing, each of the first through fourth mid-band linear arrays 210-1 through 210-4 is shown in FIG. 2B as including a total of six mid-band radiating elements 300 that are arranged in respective vertically-extending columns. It will be appreciated that typically each mid-band linear array will include a larger number of mid-band radiating elements 300. For example, FIG. 2A shows each mid-band linear array 210 as having thirteen radiating elements, which is more typical. The number of mid-band radiating elements 300 included in each mid-band linear array 210 may be selected, for example, based on a desired elevation beamwidth for the antenna beams generated by the mid-band linear arrays 210.

Each mid-band cavity phase shifter assembly 220 is connected to a pair of the RF ports 8 (see FIG. 2A) since the mid-band radiating elements 300 are dual-polarized radiating elements that transmit and receive RF signals at two orthogonal polarizations. Each mid-band cavity phase shifter assembly 220 includes a plurality of output RF transmission lines that may be directly connected to the mid-band radiating elements 300, as will be described in more detail below.

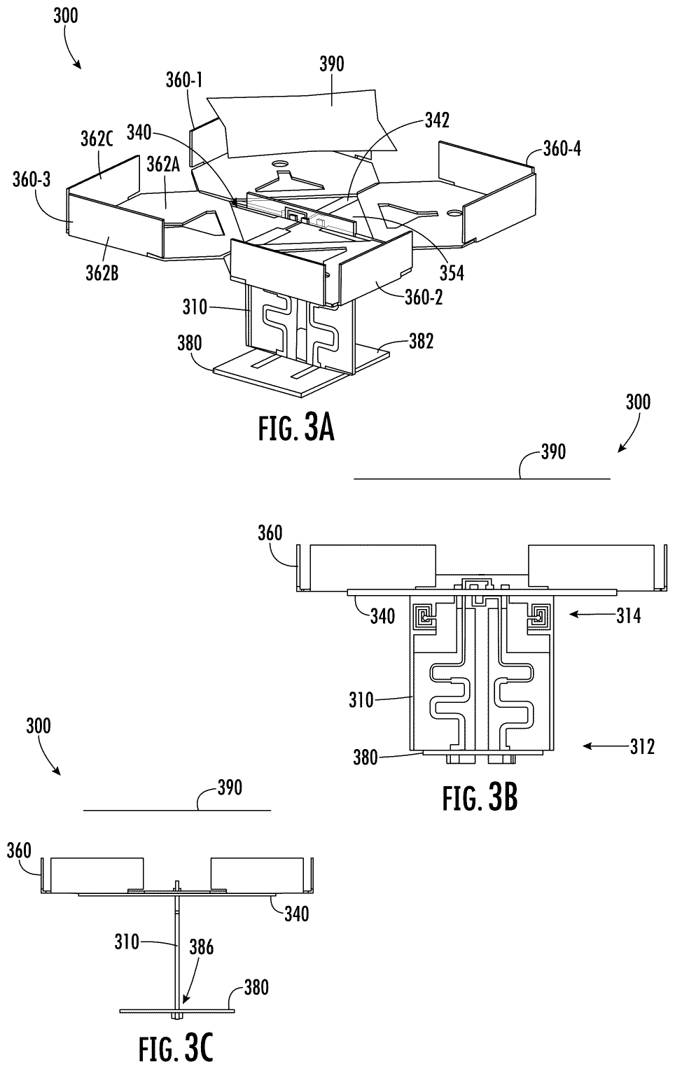

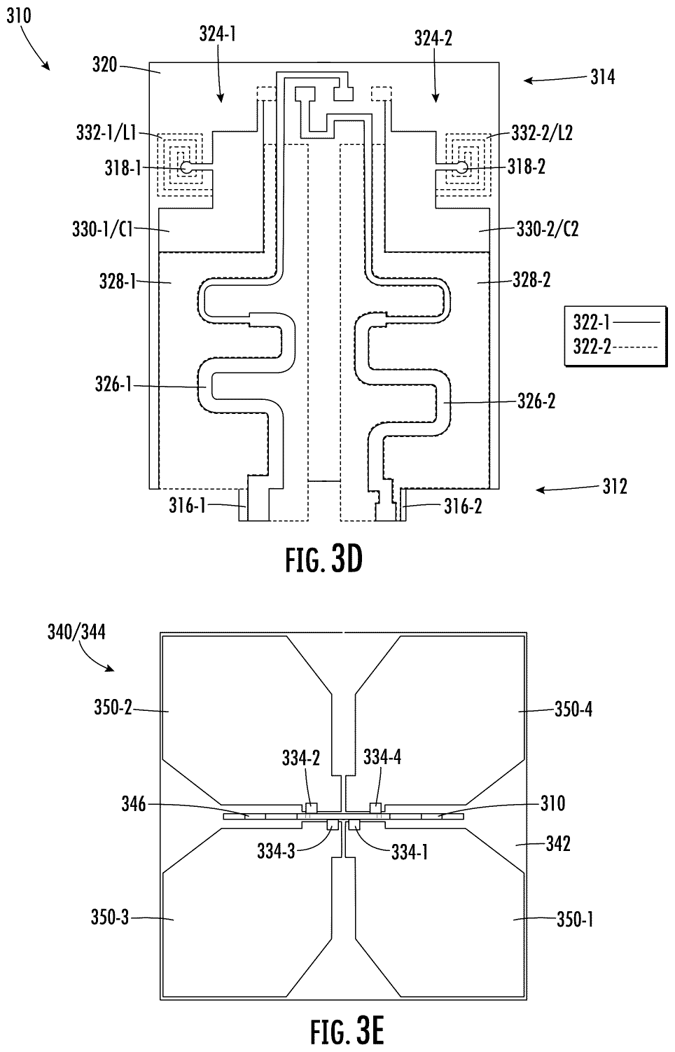

FIGS. 3A-3E illustrate one of the mid-band radiating elements 300 included in the mid-band linear array assemblies 200 of FIGS. 2A-2B. In particular, FIG. 3A is a schematic side perspective view of the mid-band radiating element 300, and FIGS. 3B and 3C are a schematic top view and a schematic side view, respectively, of the mid-band radiating element 300. FIG. 3D is a schematic top view of the feed stalk printed circuit board 310 of mid-band radiating element 300, and FIG. 3E is a front view of the dipole radiator printed circuit board 340 of mid-band radiating element 300.

Referring first to FIGS. 3A-3C, the mid-band radiating element 300 includes a single feed stalk printed circuit board 310, a dipole radiator printed circuit board 340, a plurality of sheet metal dipole arm extensions 360-1 through 360-4, a base board printed circuit board 380 and a director 390. The base board printed circuit board 380 includes a dielectric substrate 382 having a metal pad (not visible in the figures) on a rear side thereof. A rectangular slot 386 is formed through the dielectric substrate 382, and a base 312 of the feed stalk printed circuit board 310 is inserted through the slot 386. The slot 386 may be sized to provide an interference fit with the feed stalk printed circuit board 310. As will be explained below, the base board printed circuit board 380 may mechanically support the feed stalk printed circuit board 310 and may be used to couple ground signals to the feed stalk printed circuit board 310. The base board printed circuit board 380 may have a dielectric substrate 382 that comprises a low cost material such as FR4.

The feed stalk printed circuit board 310 extends forwardly at a right angle to the base board printed circuit board 380. The dipole radiator printed circuit board 340 is mounted on the distal end of the feed stalk printed circuit board 310 and is parallel to the base board printed circuit board 380. The dipole radiator circuit board 340 includes a dielectric substrate 342 and a metallization pattern 344 (see FIG. 3E) formed on the front side of the dielectric substrate 342. A rectangular slot 346 extends through the dielectric substrate 342 and the metallization pattern 344. The distal end 314 of the feed stalk printed circuit board 310 extends through the rectangular slot 346 in the dipole radiator printed circuit board 340 to mechanically mount the dipole radiator printed circuit board 340 on the feed stalk printed circuit board 310. The metallization pattern 344 includes four metal pads 350-1 through 350-4 that are arranged in the respective four quadrants of a square defined by the dielectric substrate 342. Each metal pad 350 may form at least a portion of a respective dipole arm, as will be discussed in greater detail below. As such, each metal pad 350 may also be referred to herein as a “dipole arm piece”350.

The dipole arm extensions 360 are mounted forwardly of the dipole radiator printed circuit board 340. Each dipole arm extension 360 may comprise bent piece of sheet metal. While the dipole arm extension 360-1 through 360-4 are shown as being four separate pieces of sheet metal in FIGS. 3A-3C, it will be appreciated that in other embodiments all four dipole arm extensions 360 (or subsets thereof) may be formed as a single monolithic piece of bent sheet metal. Plastic rivets (not shown) or other attachment mechanisms may be used to mount the dipole arm extensions 360 on the dipole radiator printed circuit board 340. Each dipole arm extension 360 include a first segment 362A that is parallel to the dipole radiator printed circuit board 340 as well as second and third segments 362B, 362C that extend forwardly from the first segment 362A. The second and third segments 362B, 362C increase the electrical length of each dipole arm 372 to a desired electrical length without increasing the footprint of the radiating element 300 (where the footprint is the area of the radiating element 300 when viewed from the front). Each dipole arm extension 360 may be formed by stamping the dipole arm extension 360 from a piece of sheet metal and then bending the second and third segments 362B, 362C thereof out of the plane of the first segment 362A.

In the depicted embodiment, each dipole arm extension 360 is electrically connected to a respective one of the metal pads 350 so that each combination of a metal pad 350 and the dipole arm extension 360 that is mounted thereon forms a respective dipole arm 372. In other words, the metal pads 350 may be viewed as comprising the base of each dipole arm 372 and the dipole arm extensions 360 are structures that increase the length of the base of each dipole arm to form first through fourth dipole arms 372-1 through 372-4. The first and second dipole arms 372-1, 372-2 form a first dipole radiator 370-1 and the third and fourth dipole arms 372-3, 372-4 form a second dipole radiator 370-2. The first dipole radiator 370-1 may be configured to transmit and receive slant −45° RF signals, and the second dipole radiator 370-2 may be configured to transmit and receive slant +45° RF signals. One or more solder masks or other thin dielectric elements (not shown) may be positioned between the dipole radiator printed circuit board 340 and the dipole arm extensions 360 so that the metal pads 350 capacitively couple to the respective dipole arm extensions 360.

The director 390 is mounted forwardly of the first and second dipole radiators 370-1, 370-2. The director 390 is configured to narrow the beamwidth of the antenna beams generated by the mid-band linear arrays 210 in at least a portion of the mid-band operating frequency range. The director 390 may be of conventional design.

FIG. 3D is a shadow view that illustrates the metallization provided on the first and second major surfaces of the feed stalk printed circuit board 310. As shown in FIG. 3D, the feed stalk printed circuit board 310 has a base 312 and a distal (forward) end 314 that is positioned forwardly of the base 312. The feed stalk printed circuit board 310 comprises a dielectric substrate 320 that has a first metallization layer 322-1 (shown using solid lines in FIG. 3D) on one major surface of the dielectric substrate 320 and a second metallization layer 322-2 (shown using dashed lines in FIG. 3D) on the other major surface of the dielectric substrate 320. The dielectric substrate 320 includes a pair of rearwardly-extending tabs 316.

As shown in FIG. 3D, first and second signal traces 326-1, 326-2 are formed in the first metallization layer 322-1. Each signal trace 326 is implemented as a meandered metal trace that extends from the base 312 to the distal end 314 of the feed stalk printed circuit board 310. The distal ends of signal traces 326-1, 326-2 may be enlarged, as shown, to facilitate galvanically DC connecting each signal trace to a respective one of the metal pads 350 on the dipole radiator printed circuit board 340 through respective first and third solder joints 334-1, 334-3 (see FIG. 3E). First and second metal pads 330-1, 330-2 are also formed in the first metallization layer 322-1.

First and second ground lines 328-1, 328-2 are formed in the second metallization layer 322-2. The majority of each ground line 328 is formed as a wide metal pad, but each ground line 328 narrows to a thinner trace near the distal end thereof. The distal end of each ground line 328 may be enlarged, as shown, to facilitate galvanically DC connecting ground lines 328-1, 3282 to a respective one of the metal pads 350 on the dipole radiator printed circuit board 340 through respective second and fourth solder joints 334-2, 334-4 (see FIG. 3E). The first signal trace 326-1 overlaps the first ground line 328-1 to form a first microstrip RF transmission line 324-1, and the second signal trace 326-2 overlaps the second ground line 328-2 to form a second microstrip RF transmission line 324-2. First and second spiralled traces 332-1, 332-2 are also formed in the second metallization layer 322-2 that form respective first and second inductors L1, L2. A first end of each spiralled trace 332-1, 332-2 is galvanically connected to a respective one of the first and second ground lines 328-1, 328-1, while the second end of each spiralled trace 332-1, 332-2 is galvanically connected to a respective one of the first and second metal pads 330-1, 330-2 through respective plated through holes 318-1, 318-2 that extend through the dielectric substrate 320. The first metal pad 330-1 overlaps and hence capacitively couples with the first ground line 328-1 to form a first capacitor C1, and the second metal pad 330-2 overlaps and hence capacitively couples with the second ground line 328-2 to form a second capacitor C2. The first spiral inductor L1 is electrically connected in parallel to the first capacitor C1 to form a first parallel LC circuit LC₁, and the second spiral inductor L2 is electrically connected in parallel to the second capacitor C2 to form a second parallel LC circuit LC₂.

FIG. 3E is a front top view of the dipole radiator printed circuit board 340 that illustrates the electrical connections between the feed stalk printed circuit board 310 and the dipole radiator printed circuit board 340. As shown in FIG. 3E, first and third solder joints 334-1, 334-3 galvanically DC connect the first and second signal traces 326-1, 326-2 to the respective first and third dipole arm pieces 350-1, 350-3. Second and fourth solder joints 334-2, 334-4 galvanically DC connect the first and second ground lines 328-1, 328-2 to the respective second and fourth dipole arm pieces 350-2, 350-4.

As can best be seen in FIG. 3D, the feed stalk printed circuit board 310 only includes two common mode resonance rejection circuits, namely the first parallel LC circuit LC₁ and the second parallel LC circuit LC₂. The two common mode resonance rejection circuits LC₁, LC₂ are implemented on the connections between the first and second ground lines 328-1, 328-2 and the respective second and fourth dipole arm pieces 350-2, 350-4. No common mode resonance rejection circuit is provided along the connections between the first and second signal traces 326-1, 326-2 and the respective first and third dipole arm pieces 350-1, 350-3. The common mode resonance rejection circuits may be omitted on the signal traces 326 because the first and third dipole arm pieces 350-1, 350-3 are not connected to ground and hence common mode currents will not be induced along the combination of the signal traces 326 and the dipole arms 372 to which they are connected.

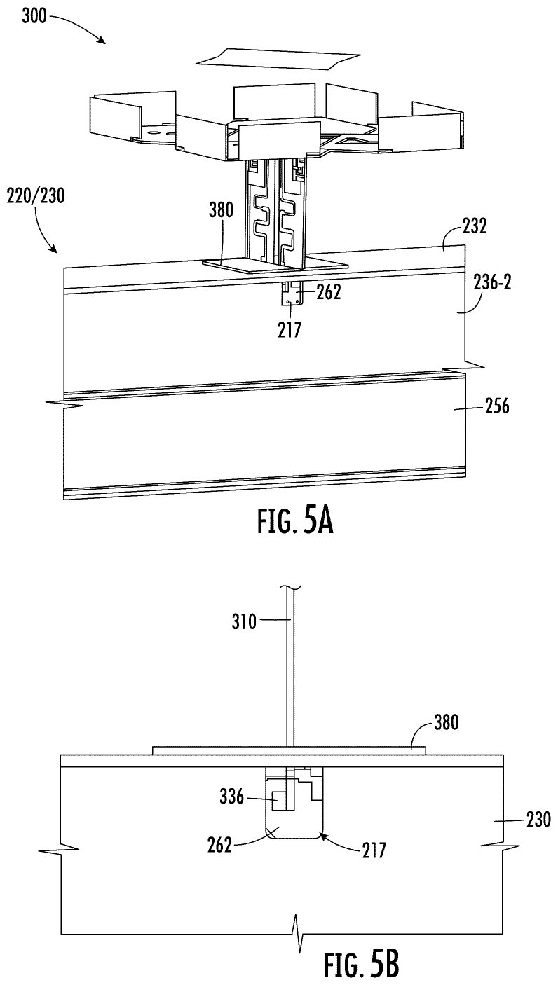

As can also be seen from FIG. 3D, the two common mode resonance rejection circuits LC₁, LC₂ take up a significant amount of room on the feed stalk printed circuit board 310, since the capacitors C1, C2 and the spiral inductors L1, L2 each require a significant amount of area near the distal end of feed stalk printed circuit board 310. It may be difficult to form four common mode resonance rejection circuits on a single feed stalk printed circuit board. For example, U.S. Pat. No. 12,021,315 discloses a mid-band radiating element that has four common mode resonance rejection circuits, namely a common mode resonance rejection circuit is interposed along the connections between the four ground lines and the four dipole arms. A total of four common mode resonance rejection circuits may be provided because the mid-band radiating elements of U.S. Pat. No. 12,021,315 (see FIGS. 5C and 7A-7B) include feed stalks that have two feed stalk printed circuit boards per radiating element. The use of two feed stalk printed circuit boards, however, increases the cost of the radiating element (particularly as expensive RF-quality printed circuit boards are used to implement the feed stalk printed circuit boards), and the larger feed stalk printed circuit boards with increased amounts of metallization tend to scatter RF radiation emitted by nearby high-band radiating elements, degrading the high-band antenna beams. This is particularly true when the high-band antenna beams are scanned in the azimuth plane, since more of the high-band radiation may impinge on the mid-band feed stalks. Moreover, in the mid-band radiating elements disclosed in U.S. Pat. No. 12,021,315, the feed stalk printed circuit boards are arranged at angles of −45° and +45° with respect to the longitudinal axis of the linear arrays, which means that the RF radiation that is scanned in the azimuth plane will impinge on the feed stalk printed circuit boards at angles of about +/−45°, so that the RF radiation will impinge on a significant amount of metal.

Referring to FIGS. 3A-3E, pursuant to some embodiments of the present invention, radiating elements 300 are provided that comprise a feed stalk printed circuit board 310 and a dipole radiator printed circuit board 340 that is mounted on the feed stalk printed circuit board 310. The feed stalk printed circuit board comprises a first ground line 328-1 that includes a first integrated parallel LC circuit LC₁ and a second ground line 328-2 that includes a second integrated parallel LC circuit LC₂. The feed stalk printed circuit board 310 also includes a first signal trace 326-1 that extends through an opening 346 in the dipole radiator printed circuit board 340 and a second signal trace 326-2. In some embodiments, the second signal trace 326-2 may extend through the opening 346.

The dipole radiator printed circuit board 340 may include a first dipole arm piece 350-1 and a second dipole arm piece 350-2 that are each at least part of a first dipole radiator 370-1, and a third dipole arm piece 350-3 and a fourth dipole arm piece 350-4 that are each at least part of a second dipole radiator 370-2. The first signal trace 326-1 may be galvanically connected to the first dipole arm piece 350-1 and the second signal trace 326-2 may be galvanically connected to the third dipole arm piece 350-3.

In some embodiments, the first and second signal traces 326-1, 326-2 each have a plurality of meandered segments. For example, a first portion of the first signal trace 326-1 may have a wave shape with at least two peaks and two valleys. In some embodiments, no parallel LC circuit is integrated into either the first signal trace or the second signal trace 326-1, 326-2.

The radiating element 300 may further comprise a first dipole arm extension 360-1 that is electrically connected to the first dipole arm piece 350-1, a second dipole arm extension 360-2 that is electrically connected to the second dipole arm piece 350-2, a third dipole arm extension 360-3 that is electrically connected to the third dipole arm piece 350-3, and a fourth dipole arm extension 360-4 that is electrically connected to the fourth dipole arm piece 350-4. The first dipole arm extension 360-1 may overlap the first dipole arm piece 350-1 in a forward direction and/or may extend outwardly beyond an outer perimeter of the first dipole arm piece 350-1. In some embodiments, the first dipole arm extension 360-1 may comprise a sheet metal dipole arm extension that includes a first portion 362A that extends in parallel to the first dipole arm piece 350-1 and a second portion 362B that extends at an oblique angle from the first portion 362A. In some embodiments, the first dipole arm extension 360-1 is capacitively coupled to the first dipole arm piece 350-1. In some embodiments, the first through fourth dipole arm extensions 360-1 through 360-4 are separate pieces. In other embodiments, at least two of the first through fourth dipole arm extensions 360-1 through 360-4 are implemented in a single piece of sheet metal.

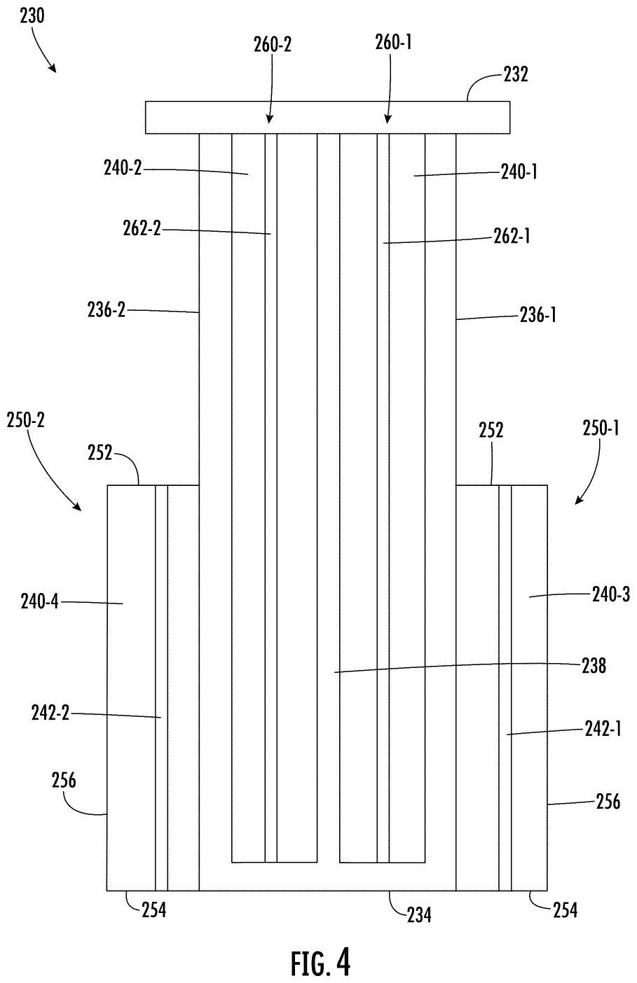

FIG. 4 is a schematic end view of one of the cavity phase shifter assemblies 220 of FIG. 2B. As shown in FIG. 4, the cavity phase shifter assembly 220 includes a longitudinally-extending metal shell 230. The metal shell 230 may be formed, for example, by extrusion. First and second longitudinally-extending cavities 240-1, 240-2 are defined within the metal shell 230. The metal shell 230 includes a front wall 232, a rear wall 234 and a pair of main sidewalls 236-1, 236-2 that together define the first and second cavities 240-1, 240-2. As shown, the first and second cavities 240-1, 240-2 may share a common sidewall 238 in some cases. The metal shell 230 further includes a first generally c-shaped structure 250-1 that extends laterally from the first main sidewall 236-1 and a second generally c-shaped structure 250-2 that extends laterally from the second main sidewall 236-2. Each generally c-shaped structure 250 may have a front wall 252 that extends parallel to the front wall 232, a rear wall 254 that extends parallel to (and possible coplanar with) the rear wall 234, and a sidewall 256 that extends parallel to the main sidewalls 236. The first generally c-shaped structure 250-1 and the first main sidewall 236-1 define a third cavity 240-3 and the second generally c-shaped structure 250-2 and the second main sidewall 236-2 define a fourth cavity 240-4. A longitudinal axis of each cavity 240 extends parallel to a longitudinal axis of the base station antenna 100.

A first phase shifter assembly 260-1 is mounted in the first cavity 240-1, and a second phase shifter assembly 260-2 is mounted in the second cavity 240-2. Each phase shifter assembly 260 may comprise, for example, a phase shifter printed circuit board 262 with RF transmission lines formed thereon. Each phase shifter printed circuit board 262 may include an input RF transmission line (not shown) such as a metal pad or trace that is electrically connected to a feed network of the base station antenna 100, a power divider (not shown) that splits RF signals input through the input RF transmission line into a plurality of sub-components, and a plurality of output RF transmission lines (not shown) where the phase adjusted sub-components of the RF signal are output. Each phase shifter assembly 260 may also include a phase shifter (not shown), such as a sliding dielectric phase shifter, that is configured to impart an adjustable phase taper to the sub-components of the RF signal before they reach the respective output RF transmission lines. First and second RF feed lines 242-1, 242-2 (e.g., stripline RF feed lines) may be disposed in the third and fourth cavities 240-3, 240-4. The first and second RF feed lines 242-1, 242-2 may be electrically connected to the respective input RF transmission lines on the first and second phase shifter printed circuit boards 262-1, 262-2.

Cavity phase shifter assemblies are known in the art. For example, U.S. Pat. No. 11,677,141 discloses a variety of cavity phase shifter assemblies and discusses the operation thereof. The entire content of U.S. Pat. No. 11,677,141 is incorporated herein by reference.

Cavity phase shifter assemblies are typically used as they include low-loss stripline RF transmission lines and because they can be designed to provide cableless connections to the radiating elements, which reduces the number of solder joints. While FIG. 4 illustrates one cavity phase shifter design, it will be appreciated that any suitable cavity phase shifter assembly design may be used to implement the cavity phase shifter assemblies 220, including any of the cavity phase shifter assemblies disclosed in U.S. Pat. No. 11,677,141.

FIG. 5A is a schematic side perspective view of the mid-band radiating element 300 of FIGS. 3A-3E mounted on the cavity phase shifter assembly 220 of FIG. 4. FIG. 5B is an enlarged side view of a portion of FIG. 5A.

As shown in FIGS. 5A-5B, the mid-band radiating element 300 is mounted on the front wall 232 of the metal shell 230 so that the base board printed circuit board 380 is parallel to the front wall 232. While not visible in FIGS. 5A-5B, one or more openings are provided in the front wall 232 and the rearwardly extending tabs 316-1, 316-2 on the on the feed stalk printed circuit board 310 are inserted through these openings so that base portions of the first and second signal traces 326-1, 326-2 and the first and second ground lines 328-1, 328-2 extend into the respective first and second cavities 240-1, 240-2. A solder mask (not shown) may be provided on the front wall 232 or on a metal pattern 384 that may be provided on the rear side of the base board printed circuit board 380 so that the metal shell 230 is capacitively coupled to the metal pattern 384 through the solder mask (or other dielectric layer). Windows 217 (only one window is visible in FIGS. 5A-5B) are provided in the sidewalls 236-1, 236-2 of the metal shell 230 that allow solder joints 336 to be applied within the respective cavities 240-1, 240-2. The solder joints 336 electrically connect the portions of the signal traces 326-1, 326-2 that extend onto the tabs 316-1, 316-2 to the output RF transmission lines on the respective phase shifter circuit boards 262 that are mounted in the respective cavities 240-1, 240-2. The first and second ground lines 328-1, 328-2 may similarly be electrically connected to ground references on the respective phase shifter circuit boards 262-1, 262-2 through solder joints (not shown) that are formed through the windows 217. As can also be seen from FIG. 5B, the feedboard printed circuit board 310 of each mid-band radiating element 300 intersects the phase shifter printed circuit boards 262 at an angle of 90°. This is mechanically more robust than solutions where the intersection is not at a 90° angle, and also may provide for improved solder joints.

As discussed above, the ground lines 328-1, 328-2 on feed stalk printed circuit board 310 may be directly connected to ground references on the respective phase shifter circuit boards 262-1, 262-2. Alternatively, the ground lines 328-1, 328-2 may be electrically connected to a ground reference on the base board printed circuit board 380 that is capacitively connected to the ground references on the respective phase shifter circuit boards 262-1, 262-2. For example, the base board printed circuit board 380 may include the above-discussed metal pad 384 on a rear side thereof that capacitively couples with the metal shell 230 of the cavity phase shifter assembly 220. The metal shell 230 of the cavity phase shifter assembly 220 may be electrically connected to the ground references on the respective phase shifter circuit boards 262-1, 262-2. The ground lines 328-1, 328-2 may be electrically connected to the metal pad 384 on the rear side of the base board printed circuit board 380.

The mid-band radiating elements 300 according to embodiments of the present invention may have advantages over conventional mid-band linear arrays. First, they may have smaller, less expensive feed stalks as compared to other mid-band radiating elements that have common mode resonance rejection circuits. Second, they may include a single feed stalk printed circuit board that has major surfaces that that extend perpendicular to the forward direction. As a result, RF radiation from nearby high-band radiating elements that is scanned in the azimuth plane will travel parallel to the metallization layers on the feed stalk printed circuit board and hence will experience very low scattering levels. Thus, the mid-band radiating elements 300 may have less impact on nearby high-band arrays. Third, since the mid-band linear array assemblies 200 are modular components, they can be almost completely assembled before they are installed in the base station antenna 100. This simplifies the manufacturing process. Fourth, since the dipole arm extensions 360 and directors 390 of the mid-band radiating elements 300 may be removably attached to the remainder of the mid-band linear array assembly 200 before the mid-band linear array assembly 200 is installed in the base station antenna 100, the entire assembly 200 may be pre-tested before it is installed in the antenna 100. Fifth, since the mid-band linear array assembly 200 is modular in nature if problems are identified later during antenna level testing, the mid-band linear array assembly 200 can readily be removed from the base station antenna 100 without removing various other components, making it much easier to fix problems (e.g., poor solder joints) detected during antenna level testing.

The present invention has been described above with reference to the accompanying drawings. The present invention is not limited to the illustrated embodiments. Rather, these embodiments are intended to fully and completely disclose the present invention to those skilled in this art. In the drawings, like numbers refer to like elements throughout. Thicknesses and dimensions of some components may be exaggerated for clarity.

Spatially relative terms, such as “under,” “below,” “lower,” “over,” “upper,” “top,” “bottom,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “under” or “beneath” other elements or features would then be oriented “over” the other elements or features. Thus, the example term “under” can encompass both an orientation of over and under. The device may be otherwise oriented (rotated 90 degrees or at other orientations) and the spatially relative descriptors used herein interpreted accordingly.

Herein, the terms “attached,” “connected,” “interconnected,” “contacting,” “mounted,” “coupled,” and the like can mean either direct or indirect attachment or coupling between elements, unless stated otherwise.

Well-known functions or constructions may not be described in detail for brevity and/or clarity. As used herein the expression “and/or” includes any and all combinations of one or more of the associated listed items.

The terminology used herein is for the purpose of describing particular embodiments only and is not intended to be limiting of the present invention. As used herein, the singular forms “a,” “an,” and “the” are intended to include the plural forms as well, unless the context clearly indicates otherwise. It will be further understood that the terms “comprises,” “comprising,” “includes,” and/or “including” when used in this specification, specify the presence of stated features, operations, elements, and/or components, but do not preclude the presence or addition of one or more other features, operations, elements, components, and/or groups thereof.

1. A radiating element, comprising:
a feed stalk printed circuit board; and
a dipole radiator printed circuit board mounted on the feed stalk printed circuit board, wherein the feed stalk printed circuit board includes:
a first ground line that includes a first integrated parallel inductor-capacitor (“LC”) circuit;
a second ground line that includes a second integrated parallel LC circuit;
a first signal trace that extends through an opening in the dipole radiator printed circuit board; and
a second signal trace.

2. The radiating element of claim 1, wherein the second signal trace extends through the opening.

3. (canceled)

4. The radiating element of claim 1, wherein the dipole radiator printed circuit board includes a first dipole arm piece and a second dipole arm piece that are each at least part of a first dipole radiator, and a third dipole arm piece and a fourth dipole arm piece that are each at least part of a second dipole radiator.

5. The radiating element of claim 4, wherein the first signal trace is galvanically connected to the first dipole arm piece and the second signal trace is galvanically connected to the second dipole arm piece.

6. (canceled)

7. The radiating element of claim 1, wherein a first portion of the first signal trace has a wave shape with at least two peaks and two valleys.

8. (canceled)

9. The radiating element of claim 4, further comprising:
a first dipole arm extension that is electrically connected to the first dipole arm piece;
a second dipole arm extension that is electrically connected to the second dipole arm piece;
a third dipole arm extension that is electrically connected to the third dipole arm piece; and
a fourth dipole arm extension that is electrically connected to the fourth dipole arm piece.

10. The radiating element of claim 9, wherein the first dipole arm extension overlaps the first dipole arm piece in a forward direction and extends outwardly beyond an outer perimeter of the first dipole arm piece.

11. The radiating element of claim 10, wherein the first dipole arm extension comprises a sheet metal dipole arm extension that includes a first portion that extends in parallel to the first dipole arm piece and a second portion that extends at an oblique angle from the first portion.

12. The radiating element of claim 10, wherein the first dipole arm extension is capacitively coupled to the first dipole arm piece.

13-14. (canceled)

15. The radiating element of claim 1, further comprising a base board printed circuit board that includes a slot therethrough, wherein a base of the feed stalk printed circuit board is inserted through the slot in the base board printed circuit board.

16. The radiating element of claim 15 wherein a rear side of the base board printed circuit board includes a metal pad, and a plurality of ground traces on the feed stalk printed circuit board are soldered to the metal pad.

17. The radiating element of claim 16 in combination with a cavity phase shifter assembly that comprises:
a metal shell having first and second cavities;
a first phase shifter within the first cavity; and
a second phase shifter within the second cavity,
wherein the metal pad on the base board printed circuit board is mounted to capacitively couple with the metal shell.

18. The radiating element of claim 17, wherein a front wall of the metal shell includes first and second openings, and the first phase shifter comprises a first phase shifter printed circuit board and the second phase shifter comprises a second phase shifter printed circuit board, and wherein the feed stalk printed circuit board includes a first rearwardly-extending tab that extends through the first opening to contact the first phase shifter printed circuit board and a second rearwardly-extending tab that extends through the second opening to contact the second phase shifter printed circuit board.

19. A radiating element, comprising:
a feed stalk printed circuit board; and
a dipole radiator printed circuit board mounted on a distal end of the feed stalk printed circuit board;
wherein the feed stalk printed circuit board includes:
a first ground line that includes a first integrated parallel inductor-capacitor (“LC”) circuit;
a second ground line that includes a second integrated parallel LC circuit;
a first signal trace that has a plurality of meandered segments that directly connects to the dipole radiator printed circuit board and that does not include an integrated LC circuit; and
a second signal trace that has a plurality of meandered segments that directly connects to the dipole radiator printed circuit board and that does not include an integrated LC circuit.

20. The radiating element of claim 19, wherein the feed stalk printed circuit board includes a forwardly-extending tab that extends through an opening in the dipole radiator printed circuit board, and the first signal trace extends through the opening.

21. The radiating element of claim 20, wherein the second signal trace extends through the opening.

22. The radiating element of claim 19, wherein no parallel LC circuit is integrated into either the first signal trace or the second signal trace.

23-28. (canceled)

29. A radiating element, comprising:
a feed stalk printed circuit board; and
a dipole radiator printed circuit board mounted on the feed stalk printed circuit board, wherein the feed stalk printed circuit board includes:
a first ground line that includes a first integrated parallel inductor-capacitor (“LC”) circuit;
a second ground line that includes a second integrated parallel LC circuit;
a first signal trace that is galvanically connected to a first metal pad on the dipole radiator printed circuit board; and
a second signal trace that is galvanically connected to a second metal pad on the dipole radiator printed circuit board.

30. The radiating element of claim 29, wherein no parallel LC circuit is integrated into either the first signal trace or the second signal trace.

31. The radiating element of claim 29, wherein the dipole radiator printed circuit board includes a first dipole arm piece and a second dipole arm piece that are each at least part of a first dipole radiator, and a third dipole arm piece and a fourth dipole arm piece that are each at least part of a second dipole radiator.

32. The radiating element of claim 31, wherein the first signal trace is galvanically connected to the first dipole arm piece and the second signal trace is galvanically connected to the second dipole arm piece.

33. (canceled)

34. The radiating element of claim 29, further comprising a base board printed circuit board that includes a slot therethrough, wherein a base of the feed stalk printed circuit board is inserted through the slot in the base board printed circuit board.
